(19) United States
(12) Patent Application Publication
(10) Pub. No.: US 2007/0195420 A1
(43) Pub. Date: Aug. 23, 2007

(54) Extraneous light reducing lens

(76) Inventor: Mark Fitchmun, San Diego, CA (US)

Correspondence Address: David B. Waller, Suite 214, 5677 Oberlin Drive, San Diego, CA, 92121, US

(21) Appl. No.: 11/360,650

(22) Filed: Feb. 23, 2006

(51) Int. Cl. G03B 21/14; G02B 5/28

(52) U.S. Cl. 359/603; 359/589

(57) ABSTRACT

The present invention provides a lens that reduces the reflected scattered light or glare from the surface of a display screen comprising at least two of the five characteristics of polarizing light, a short wavelength pass, a long wavelength pass, yellow-orange wavelength blocking and cyan wavelength blocking.

### RELATED APPLICATIONS

This application is related to co-owned U.S. utility application entitled “Extraneous Light Reducing Lens”, to Mark Fitchmun filed Feb. 25, 2005, provisional patent application Ser. No.; 60/656,672, the entire disclosure of which is incorporated herein by reference.

### TECHNICAL FIELD

The present invention relates to lenses and devices comprising those lenses used for viewing electronic displays. More particularly, to lenses used in visual aids for viewing electronic displays, such as computer screens and cell phones under conditions where extraneous light contributes to visual fatigue or eyestrain, or simply impairs visual recognition of displayed information or images.

### BACKGROUND OF THE INVENTION

Many computer display screens have surfaces that are able to reduce a substantial amount of reflected light that interferes with the viewing of images or information displayed on the screen. These screens when used with limited background light are effective in eliminating a majority of light that can impair visualization of the computer created images. However, bright lighting in an office or sunlight (direct or reflected) introduce glare that these surfaces are unable to sufficiently reduce, making it difficult at best for the user to view images clearly. Asthenopia, visual fatigue, or eyestrain, collectively referred to as eyestrain, result from this difficulty in visualizing images displayed on electronic monitors.

Additionally, when viewing an electronic display, the observer is generally confronted with two surfaces of the viewing display panel, one being the actual displayed image, and the second being the physical surface of the monitor. The physical surface of the monitor is slightly closer to the observer than the image the being observed. This can make it more difficult to maintain focus on the image thereby contributing to eyestrain. Small particulates, oils, and abrasions (i.e. dust, fingerprints, and scratches) exacerbate this problem by increasing the visibility of the monitor's surface.

Lastly, high levels of ambient light cause the eye to become temporarily less response to light in general making it difficult to see the display image thereby contributing to eyestrain. Eyestrain can also occur when the electronically produced image is not as bright as the local environment.

Consequently, there is a need for a lens and devices comprising these lenses as visual aids for reducing light other than that comprising the electronically produced image in order to provide better visualization of images and/or information presented thereby reducing eyestrain.

### SUMMARY OF THE INVENTION

The present invention provides a novel lens and devices comprising these novel lenses such as eyeglasses wherein said lenses comprise at least two of the light filtering capabilities selected from, a light polarizing capability to selectively pass light having a polarity of the electronically produced image, a long wavelength pass capability that eliminates or reduces light having a wavelength less than about 430 nm, a short pass capability that attenuates light having a wavelength greater than about 650 nm, a band blocking capability that attenuates light around 515 nm, and a band blocking capability that attenuates around 580 nm.

In one aspect of the invention, the at least two of the five capabilities may be provided in one or more filters affixed together.

In one embodiment, the lens may further comprise an antiglare coating.

In another embodiment, the lens may further comprise a positive focal length such as for example a positive focal length of not less than about 0.2 meters and not more than about 5 meters.

### DESCRIPTION OF THE FIGURE

FIG. 1 Is a line graph showing the wavelengths of light emitted from a commercially available display screen (solid line), sunlight reflected from the surface of the display screen (dotted line) and the resulting light as would be observed by the user of the device (dashed line);

FIG. 2 Is an area graph showing a different view of the same data as provided in FIG. 1. The dark grey represents light produced by a panel display, and the light grey represents reflected sunlight obscuring the image. The pie chart (inset) shows that less than one third of the light reaching the observer from the display is that of the image. The other two thirds is extraneous light that degrades image quality.; and

FIG. 3 Is a line graph showing the characteristics of a lens used to test the current invention (solid grey line). This lens comprised four filters, with each filter having a desired characteristic. Spectral qualities for three of the filters are also shown; a 430 nm long pass filter (dotted line), a 650 nm short pass filter (dashed line), and a sheet of didymium doped glass having strong adsorption bands about 515 nm and 580 nm (dash/dot). The forth filter, a linear polarizer is not shown as it does not discriminate between wavelengths in the visible spectrum;

FIG. 4: Is a line graph comparing spectral qualities of the prototype lens of FIG. 3 (solid line) to an envisioned lens having more desirable characteristics (dotted line);

FIG. 5: Is an area graph showing the effect of placing the prototype lens described in FIGS. 3 and 4 between the display and the observer. The lighting conditions are the same as in FIGS. 1 and 2. Most of the extraneous light (light grey) has been blocked, and although 59% of the desired light from the monitor (dark grey) has also been blocked, the ratio of extraneous to desired light from the monitor has improved by a factor of four (pie chart inset;

FIG. 6: Is an area graph showing the theoretical performance of the envisioned, more desirable, lens from FIG. 3. Note that compared to the prototype lens, the transmitted light from the image (light grey) is increased, while the extraneous light is further reduced. (doted line). Overall, the ratio of desired light from the monitor to undesired extraneous light is improved by a factor of almost eight as compared to starting shown in FIGS. 1 and 2; and

FIG. 7: Is an exploded diagrammatic representation of a pair of eye glasses comprising a lens of the present invention wherein the filters having the desired characteristics are joined into a single lens.

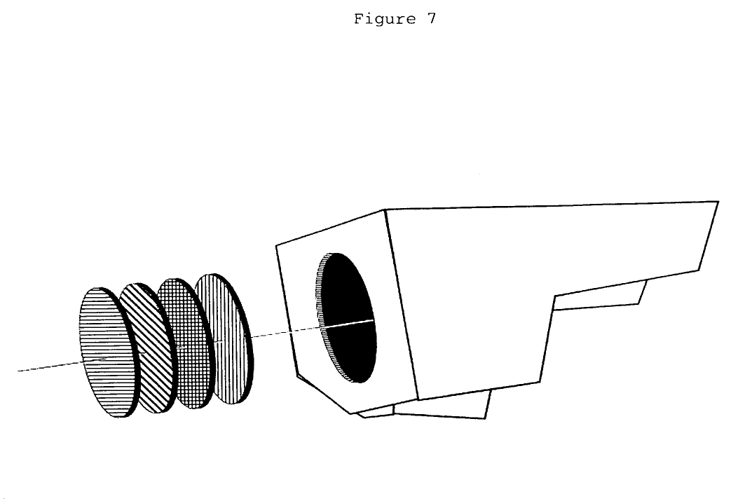

### DETAILED DESCRIPTION OF THE INVENTION

Unless defined otherwise, all terms used herein have the same meaning as is commonly understood by one of skill in the art to which this invention belongs. All patents, patent applications and publications referred to throughout the disclosure herein are incorporated by reference in their entirety. In the event that there is a plurality of definitions for a term herein, those in this section prevail.

The term “affixed” as used herein refers to securing one element of the invention to another element by a variety of methods known to one skilled in the art. For example, a notch filter may be affixed to a band pass filter by adhesive that does not interfere with the desirable characteristics of the two filters.

The term “fused” or “fusion” as used herein refers to two separate elements that are joined permanently so that they cannot be separated from one another. For example, wherein a filter having a light polarizing ability is fused with a long wavelength pass filter that reduces or eliminates the transmission through the lens of light having a wavelength of about 430 nm and below. In this case, the polarizing filter and long wavelength pass filter are joined into a single lens having these two distinct characteristics.

The term “provided on” as used herein refers to one element being affixed, fused, applied to or otherwise connected to another element wherein both elements are distinct and separate from each other. Such as, for example, wherein a polarizing film is affixed to the surface of a glass short wavelength pass filter that reduces or eliminates the transmission through the lens of light having a wavelength of 650 nm and above.

The present invention provides an optical lens comprising at least two of the five characteristics of polarizing light, a short wavelength pass, a long wavelength pass, yellow-orange wavelength blocking and cyan(blue-green) blocking.

The light comprising images produced by electronic displays can often be characterized by one or both of two distinct features. First; the light is often polarized and second; the light is often confined to three color bands, one each in the red, green, and blue portions of the visible spectrum. Therefore, light not having these characteristics is generally not needed to visualize the image. In fact, this “extraneous” light is generally detrimental to image quality, thereby adding to eyestrain.

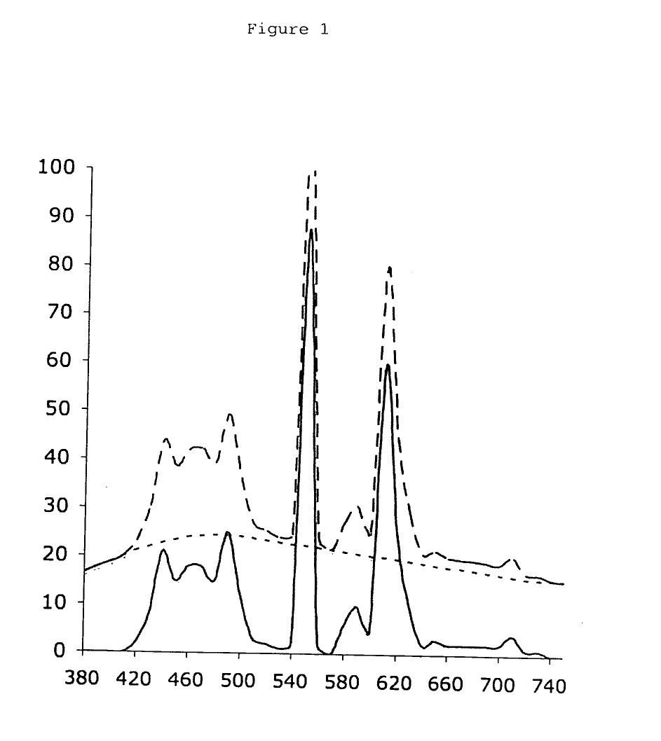

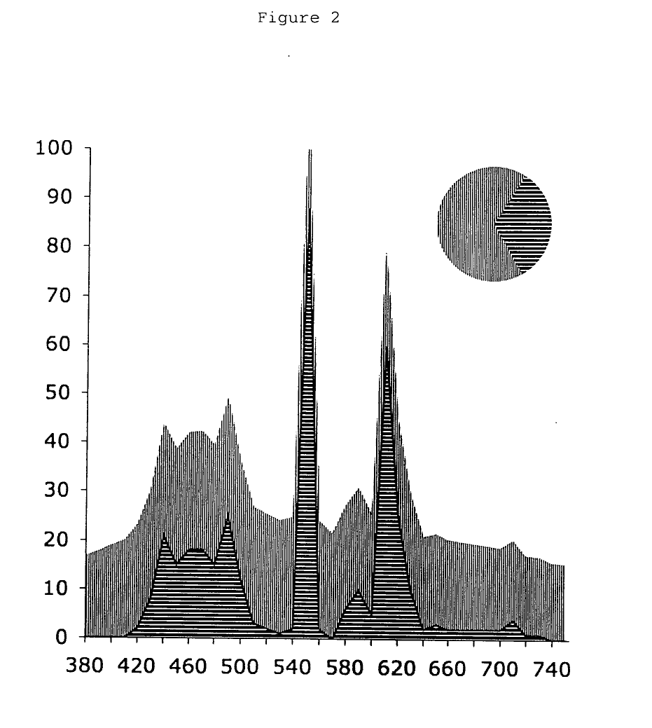

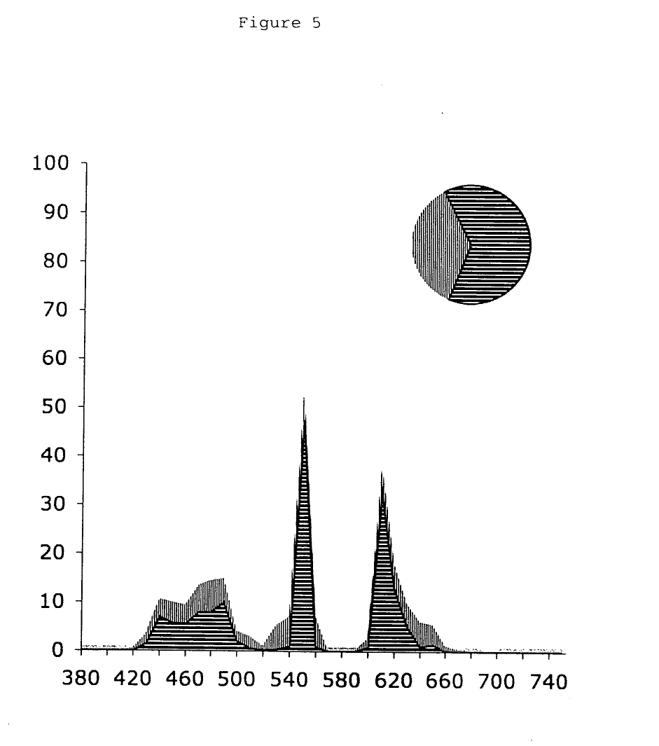

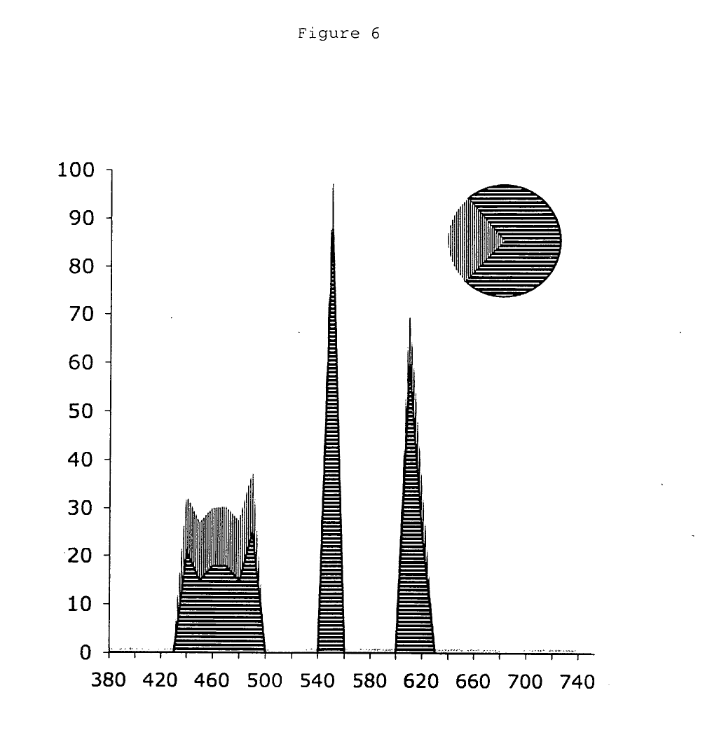

A desirable polarizing characteristic preferably blocks approximately one half (50%) of non-polarized (randomly polarized) light. Most ambient light not originating from an electronic display is randomly polarized, consequently approximately 50% will be blocked by a polarizing filter. This applies to light reflected off the display as well as surrounding objects. Also, polarized light emitted by electronic displays will become depolarized when it encounters particulates, oils, and abrasions of the monitor's surface (see FIGS. 1 and 2) A polarizing filter will remove about 50% of this light. Preferably, the polarizing filter of the present invention is in the same general orientation as the light emitted by the electronic display. A plane polarizing filter with the plane of polarization tipped 45° from vertical was used for FIGS. 5 and 6.

The short wavelength pass characteristic preferably reduces or eliminates light having a wavelength longer than that primarily emitted by the display screen in the red portion of the visible spectrum. Red light emitted by the display, being primarily below the filter's cutoff is not significantly effected, while a significant portion of extraneous red light prominent in tungsten filament and other light sources is above the cutoff and therefore selectively blocked.

The long pass characteristic reduces or eliminates light having a wavelength shorter than that primarily emitted by the display screen in the blue portion of the visible spectrum. Blue light emitted by the display, being primarily above the filter's cutoff is not significantly effected, while a significant portion of extraneous violet light prominent in sunlight and other sources is above the cutoff and therefore selectively blocked.

The yellow/orange blocking characteristic preferably reduces or eliminates light having a wavelength longer than that primarily produced by the display screen in the green portion and shorter than that primarily emitted in the red portion of the spectrum. Yellow and orange light emitted by the display (created by blending red and green light) being primarily outside the wavelengths blocked by the filter is not significantly effected while a significant portion of extraneous yellow and orange light prominent is many light sources is within the band of blocked and therefore selectively blocked.

The cyan blocking characteristic preferably reduces or eliminates light having a wavelength longer than that primarily produced by the display screen in the blue portion and shorter than that primarily emitted in the green portion of the spectrum. Cyan light emitted by the display (created by blending blue and green light) being primarily outside the wavelengths blocked by the filter is not significantly effected while a significant portion of extraneous cyan is within the band of blocked and therefore selectively blocked.

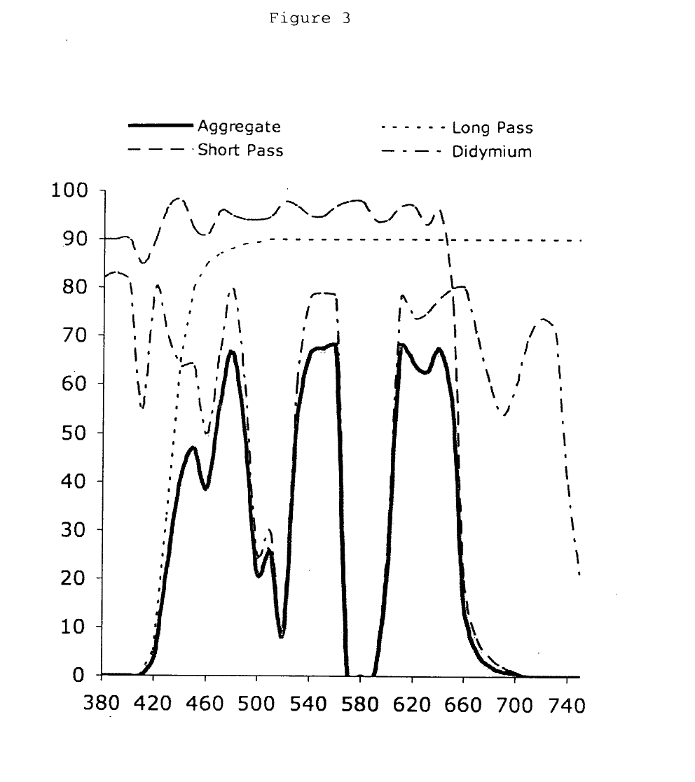

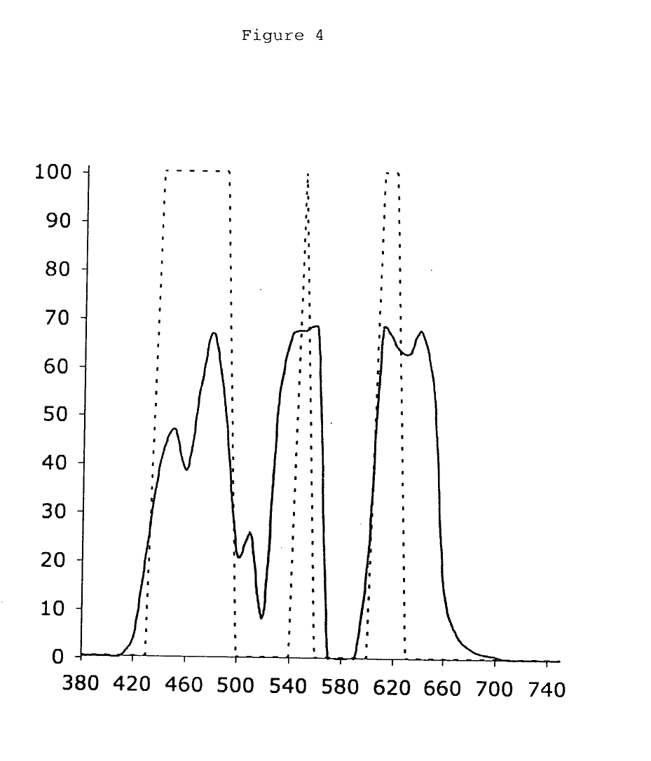

In one embodiment, the long pass filter allows passage of light having a wavelength greater than 430 nm, wherein the short pass filter allows passage of light having a wavelength less than 650 nm, wherein the yellow-orange blocking filter reduces or eliminates light from about 555 nm to about 605 nm, and wherein the cyan blocking filter reduces or eliminates light from about 500 nm to about 530 nm (see FIGS. 3 and 4).

One characteristic that the lens of the present invention may have is the ability to polarize light thereby blocking much of the light reflected from a surface. Polarizing filter capabilities may be provided on a variety of materials that may be used to construct the lens such as for example glass or plastic film. A multitude of polarizing filters are available commercially that may be used to construct the lens such as the polyvinyl alcohol-iodine polarizing film available through polarization.com (San Antonio, Tex.). If the polarizing characteristic is provided as a film, it may be applied or affixed to a more rigid surface such as glass by for example an adhesive. Proper orientation of a lens of the present invention comprising a polarizing characteristic will be based on the polarized orientation of the display screen the user will be viewing. The display polarizing orientation may be determined using a handheld gage comprising windows containing polarizing filters of know orientations. Another characteristic that the lens of the present invention may have is the ability to eliminate or reduce the passage of light of a particular wavelength and wavelengths below such a particular wavelength. Such filters are known as long pass filters. In one embodiment the long pass filter reduces or eliminates the passage of light through the lens of wavelengths below the wavelengths primarily produced by the desired display in the blue range of the spectrum. More particularly, in the range of about 450 nm and below and preferably, about 430 nm and below. A multitude of long pass filters are available commercially that may be used to construct the lens such as the GG435 glass from Melles Griot BV (part #03FCG061, Netherlands).

Another characteristic that the lens of the present invention may have is the ability to reduce or eliminate the passage of light of a particular wavelength and wavelengths above that particular wavelength. Such filters are known as short pass filters. In one embodiment, the short pass filter reduces or eliminates the passage of light through the lens of wavelengths above the wavelengths primarily produced by the desired display in the red range of the spectrum. More particularly, in the range of about 650 nm and above. Preferably, about 640 nm and above. A multitude of short pass filters are available commercially that may be used to construct the lens such as dichroic coating on fused quartz from Melles Griot BV (part #03SWP612, Netherlands).

Another characteristic of the lens of the present invention is the ability to eliminate or reduce the passage of light in a particular wavelength range. Such filters are known as notch filters. In one embodiment, the notch filter prevents the passage of light through the lens of wavelengths between the prominent bands emitted by the desired display, such as the yellow-orange range of the spectrum which occurs between the green and red emissions of a display. More particularly, in the range from about 560 nm to about 600 nm. Most preferably, from about 555 nm to about 605 nm.

Another characteristic of the lens of the present invention is the ability to eliminate or reduce the passage of light in the cyan range of the spectrum between the prominent blue and green bands emitted by the desired display. More particularly, in the range from about 505 nm to about 530 nm. Most preferably, from about 500 nm to about 540 nm. In another preferred embodiment both notch filters are combined and eliminate desired wavelengths in both the yellow-orange and cyan regions of the spectrum. Such a filter can be approximated with didymium doped glass. More exacting filters can also be constructed using readily available technologies.

Another characteristic that the lens of the present invention may have is to provide additional reduction in glare by the use of commercially available antiglare coatings.

Another characteristic that the lens of the present invention may have is to provide a positive focal length such as for example from about 0.2 to about 5 meters.

In preferred embodiments of the present invention, the lens may be provided with one or more of the characteristics discussed above in a single lens or may be provided in one or more filters in close proximity to one another to allow the characteristic desired to function cooperatively in the lens. When one or more filters are combined it is preferable that they are fused by an adhesive that does not deter from the desired filter characteristics joined from the fusion.

In use, the lens having the desired characteristics is ground or cut into appropriate sized shapes for insertion into an eye glass housing that allows the user to maintain the lens or lenses in place between the display and the eye.

I claim:

1. An extraneous light reducing lens comprising; at least two of the light filtering capabilities selected from, a light polarizing capability to selectively pass light having a polarity of an electronically produced image, a long wavelength pass capability that eliminates or reduces light having a wavelength less than about 430 nm, a short wavelength pass capability that attenuates light having a wavelength greater than about 650 nm, a band blocking capability that attenuates light around 515 nm, and a band blocking capability that attenuates around 580 nm.

2. An extraneous light reducing lens according to claim 1 wherein said at least two light filtering capabilities are provided in two or more lenses that are affixed together.

3. An extraneous light reducing lens according to claim 1 further comprising an available antiglare coating.

4. An extraneous light reducing lens according to claim 1 further comprising a positive focal length of not less than about 0.2 meters

5. An extraneous light reducing lens according to claim 1 further comprising a positive focal length of not more than about 5 meters.

6. A pair of glasses comprising at least one extraneous light reducing lens having at least two of the light filtering capabilities selected from the group consisting of a light polarizing capability to selectively pass light having a polarity of an electronically produced image, a long wavelength pass capability that eliminates or reduces light having a wavelength less than about 430 nm, a short wavelength pass capability that attenuates light having a wavelength greater than about 650 nm, a band blocking capability that attenuates light around 515 nm, and a band blocking capability that attenuates around 580 nm.
